(19) United States
(12) Patent Application Publication
(10) Pub. No.: US 2025/0240619 A1
(43) Pub. Date: Jul. 24, 2025

(54) VALIDATION OF PRIVACY REQUESTS FOR MUTUAL ACCESS POINT (AP) AND CLIENT DEVICE PROTECTION

(71) Applicant: Cisco Technology, Inc., San Jose, CA (US)

(72) Inventors: Domenico Ficara, Essertines-sur-Yverdon (CH); Stephen M. Orr, Wallkill, NY (US); Jerome Henry, Pittsboro, NC (US); Ugo Mario Campiglio, Morges (CH); Javier Contreras, Barcelona (ES)

(73) Assignee: Cisco Technology, Inc., San Jose, CA (US)

(21) Appl. No.: 19/032,170

(22) Filed: Jan. 20, 2025

Related U.S. Application Data
(60) Provisional application No. 63/622,416, filed on Jan. 18, 2024.

(51) Int. Cl. H04W 12/02; H04W 72/0446; H04W 84/12

(52) U.S. Cl. CPC H04W 12/02; H04W 72/0446; H04W 84/12

(57) ABSTRACT

Validation of privacy requests for mutual Access Point (AP) and client device protection may be provided. A first computing device may accept association with a second computing device. Then the first computing device may receive frame anonymization parameters associated with a parameter rotation from the second computing device. Next, the first computing device may determine to one of: i) accept the parameter rotation based on the frame anonymization parameters; and ii) reject the parameter rotation based on the frame anonymization parameters.

### RELATED APPLICATION

Under provisions of 35 U.S.C. § 119(e), Applicant claims the benefit of U.S. Provisional Application No. 63/622,416, filed Jan. 18, 2024, which is incorporated herein by reference.

### TECHNICAL FIELD

The present disclosure relates generally to providing validation of privacy requests for mutual Access Point (AP) and client device protection.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing validation of privacy requests for mutual Access Point (AP) and client device protection;

FIG. 2 is a flow chart of a method for providing validation of privacy requests for mutual AP and client device protection; and

FIG. 3 is a block diagram of a computing device.

### DETAILED DESCRIPTION

### Overview

Validation of privacy requests for mutual Access Point (AP) and client device protection may be provided. A first computing device may accept association with a second computing device. Then the first computing device may receive frame anonymization parameters associated with a parameter rotation from the second computing device. Next, the first computing device may determine to one of: i) accept the parameter rotation based on the frame anonymization parameters; and ii) reject the parameter rotation based on the frame anonymization parameters.

Both the foregoing overview and the following example embodiments are examples and explanatory only, and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.11bi standard may be directed to preserving privacy for client devices. In order to do this, IEEE 802.11bi may provide for obfuscating and rotating all observable parameters that may be used for an eavesdropper to identify a client device (i.e., a station (STA)) and track its activity over time.

There may be two models: i) an Access Point (AP) may propose new Media Access Control (MAC) address/parameter rotation; and ii) a STA may propose new MAC address/parameter rotation. These models may work with some request/reply communication between the AP and the STA and vice-versa. For example, the initiator may request and the other party may reply (e.g., with an Acknowledge (ACK)).

In model ii) above, STAs may have an opportunity to start a Denial-of-Service (DoS) on the AP by asking for too frequent epochs. An epoch is the time window where a MAC address and/or other privacy impacting parameters may be stable. Too short-lived epochs may have an impact on APs.

A third option not described above is when a STA changes (e.g., rotates) the MAC address for each Transmit Opportunity (TxOP), which may be the fastest possible. This TxOP-rotation case may not fall into the domain of problem addressed by embodiments of the disclosure because in such a scenario, an agreement between the AP and the STA may be done once and no specific request/response for each rotation. Embodiments of the disclosure may protect STAs and APs in the Frame Anonymization Parameter Set relationship needed for privacy reasons.

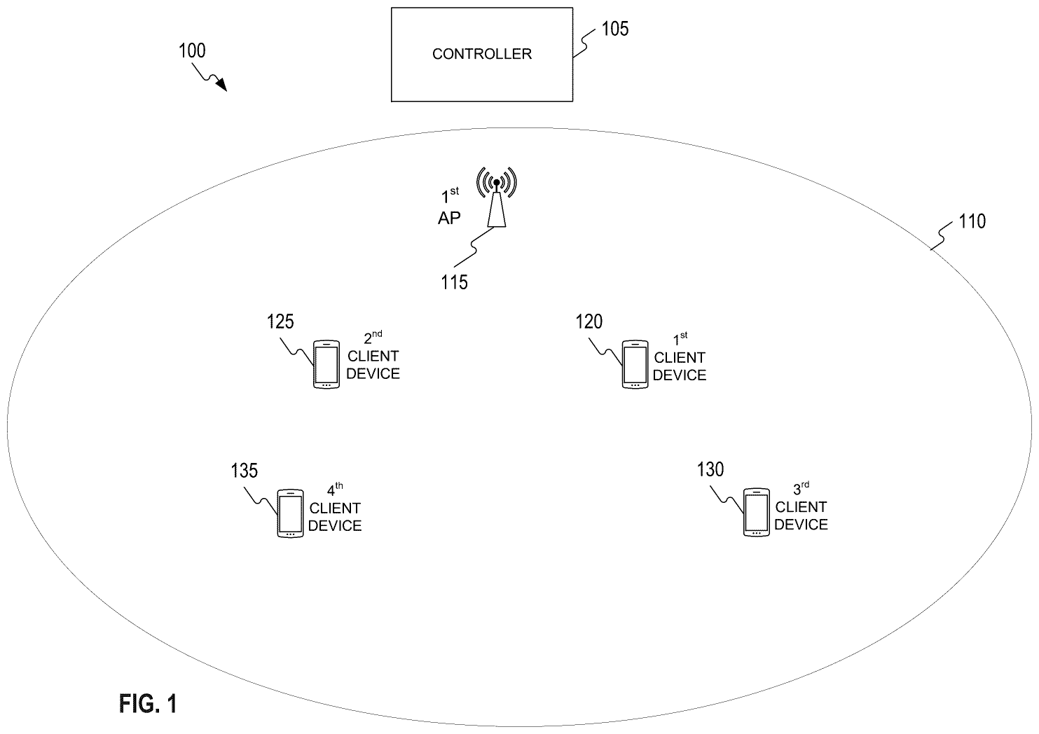

FIG. 1 shows an operating environment 100 for providing validation of privacy requests for mutual AP and client device protection. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may include, but are not limited to, a first AP 115 in addition to other APs. The plurality of APs may provide wireless network access to a plurality of client devices as they move within coverage environment 110.

The plurality of client devices may comprise, but are not limited to, a first client device 120, a second client device 125, a third client device 130, and a fourth client device 135. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. The plurality of client devices may also be Multi-user MIMO (MU-MIMO), which may comprise a set of technologies for multipath wireless communication, in which multiple users or terminals, each radioing over one or more antennas, communicate with one another. Each of the plurality of APs and the plurality of client devices may be compatible with specification standards such as, but not limited to, the Institute of Electrical and Electronics Engineers (IEEE) 802.11ax/be specification standard for example.

Controller 105 may comprise a Wireless Local Area Network Controller (WLC) and may provision and control coverage environment 110 (e.g., a WLAN). Controller 105 may allow first client device 120, second client device 125, third client device 130, and fourth client device 135 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide validation of privacy requests for mutual AP and client device protection.

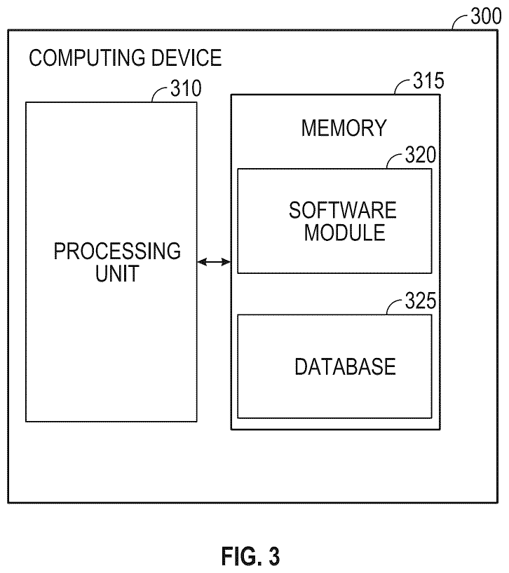

The elements described above of operating environment 100 (e.g., controller 105, first AP 115, first client device 120, second client device 125, third client device 130, or fourth client device 135) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

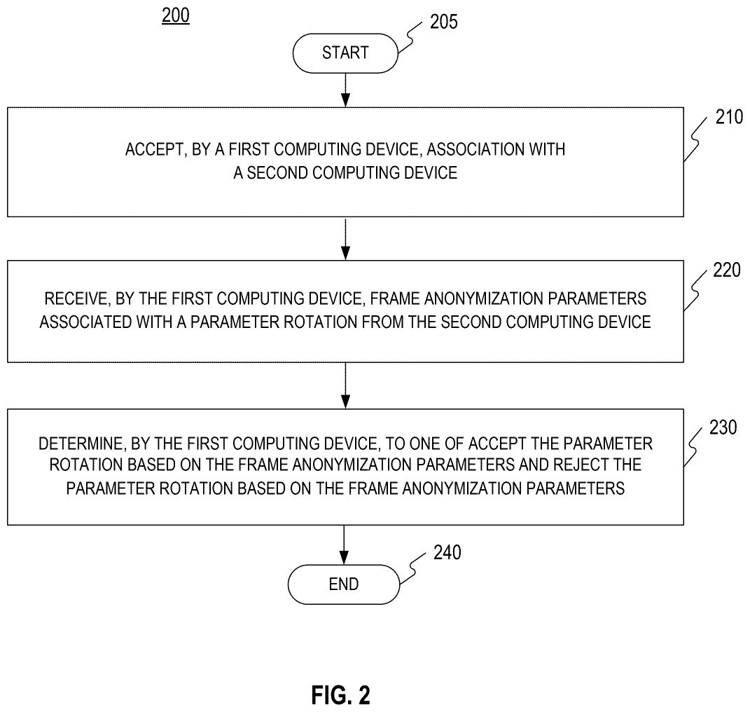

FIG. 2 is a flow chart setting forth the general stages involved in a method 200 consistent with embodiments of the disclosure for providing validation of privacy requests for mutual AP and client device protection. Method 200 may be implemented using computing device 300 as described in more detail below with respect to FIG. 3. Computing device 300 may be embodied by first AP 115 or first client device 120 for example. In one embodiment, a first computing device may comprise first AP 115 and a second computing device may comprise first client device 120. In another embodiment, the first computing device may comprise first client device 120 and the second computing device may comprise first AP 115. Ways to implement the stages of method 200 will be described in greater detail below.

Method 200 may begin at starting block 205 and proceed to stage 210 where the first computing device may accept association with the second computing device. For example, the first computing device may comprise first AP 115 and the second computing device may comprise first client device 120. First client device 120 may associate with first AP 115 and be granted access to coverage environment 110. However, other devices in the area may be eavesdropping to identify first client device 120 and track its activity over time. Embodiments of the disclosure may obfuscate and rotate all observable parameters associated with second computing device (e.g., first client device 120). The observable parameters may comprise, but are not limited to, MAC addresses, sequence numbers, packet numbers, application Identifiers (IDs), etc.

From stage 210, where the first computing device accepts the association with the second computing device, method 200 may advance to stage 220 where the first computing device may receive frame anonymization parameters associated with a parameter rotation from the second computing device. For example, the frame anonymization parameters may identify any one or more of the observable parameters described above and how frequently they are to be rotated or changed.

Once the first computing device receives the frame anonymization parameters associated with the parameter rotation from the second computing device in stage 220, method 200 may continue to stage 230 where the first computing device may determine to one of: i) accept the parameter rotation based on the frame anonymization parameters; and ii) reject the parameter rotation based on the frame anonymization parameters. Embodiments of the disclosure may be directed at protecting a process where both parties of a wireless communication (e.g., the AP and the STA) may be protected from choices of parameters of the Frame Anonymization Parameter Set requests that may be too heavy or do not work for either party.

For example, in one embodiment, the AP may reject a STA's Frame Anonymization Parameter Set request for an epoch (or MAC rotation) based on the frequency of the request. In a variation, the AP may reject the request because the AP is currently out of resources to handle the new parameter anonymization. This may be due to the AP's Central Processing Unit (CPU) load, the AP's memory load, the number of STAs associated with the AP, the number of concurrent operations, or if it is busy with other wireless operations such as Group Temporal Key (GTK) rotation.

In an extension, the AP may reject the Anonymization Parameter Set request if the request is for a long-term parameter update where a collision may be envisioned. Long term parameter update may be defined with an algorithm (e.g., STA and AP agree on a Pseudorandom Number Generator (PRNG) that generates parameter at next iterations, so that signaling is reduced). In such a cases, the AP may propose an adjustment (e.g., puncturing or skipping the sequence of next items when a collision is envisioned). Similarly the AP may reject a long term request if forecasted load of the next STAs using long-term or one-shot requests may overload the AP. In another embodiment, the AP may reject a STA's individual request if a group request is scheduled around the same time as the next individual request.

In another embodiment, the opposite may be proposed, where the STA rejects the AP's proposed parameter update if frequency is too short or too long. Too short may be heavy on the STA and too long may be useless for privacy purposes. In a variation, the STA may reject the long term parameter update if it proposes a weak algorithm or a strong algorithm with weak parameters.

Furthermore a reason code (e.g., why the request failed) may be replied to the other party in an additional signaling option of the current messaging being discussed. In positive scenarios, the AP or the STA any reply with a success status code and/or parameters to support the request. Once the first computing device determines to one of: i) accept the parameter rotation based on the frame anonymization parameters; and ii) reject the parameter rotation based on the frame anonymization parameters in stage 230, method 200 may then end at stage 240.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing validation of privacy requests for mutual AP and client device protection as described above with respect to FIG. 2. Computing device 300, for example, may provide an operating environment for controller 105, first AP 115, first client device 120, second client device 125, third client device 130, or fourth client device 135. Controller 105, first AP 115, first client device 120, second client device 125, third client device 130, or fourth client device 135 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
accepting, by a first computing device, association with a second computing device;
receiving, by the first computing device, frame anonymization parameters associated with a parameter rotation from the second computing device; and
determining, by the first computing device, to one of accept the parameter rotation based on the frame anonymization parameters and reject the parameter rotation based on the frame anonymization parameters.

2. The method of claim 1, wherein determining to one of accept the parameter rotation based on the frame anonymization parameters and reject the parameter rotation based on the frame anonymization parameters comprises determining based on a frequency of rotation for the parameter rotation obtained from the frame anonymization parameters.

3. The method of claim 2, wherein determining based on the frequency of rotation for the parameter rotation obtained from the frame anonymization parameters comprises determining that the frequency of rotation is greater than a predetermined value.

4. The method of claim 2, wherein determining based on the frequency of rotation for the parameter rotation obtained from the frame anonymization parameters comprises determining that the frequency of rotation is less than a predetermined value.

5. The method of claim 1, further comprising providing a reason for rejecting when the first computing device determines to reject the parameter rotation based on the frame anonymization parameters.

6. The method of claim 1, wherein the first computing device comprises an Access Point (AP) and the second computing device comprises a client device.

7. The method of claim 1, wherein the first computing device comprises a client device and the second computing device comprises an Access Point (AP).

8. A system comprising:
a memory storage; and
a processing unit, disposed in a first computing device and coupled to the memory storage, wherein the processing unit is operative to:
accept association with a second computing device;
receive frame anonymization parameters associated with a parameter rotation from the second computing device; and
determine to one of accept the parameter rotation based on the frame anonymization parameters and reject the parameter rotation based on the frame anonymization parameters.

9. The system of claim 8, wherein the processing unit being operative to determine to one of accept the parameter rotation based on the frame anonymization parameters and reject the parameter rotation based on the frame anonymization parameters comprises the processing unit being operative to determine based on a frequency of rotation for the parameter rotation obtained from the frame anonymization parameters.

10. The system of claim 9, wherein the processing unit being operative to determine based on the frequency of rotation for the parameter rotation obtained from the frame anonymization parameters comprises the processing unit being operative to determine that the frequency of rotation is greater than a predetermined value.

11. The system of claim 9, wherein the processing unit being operative to determine based on the frequency of rotation for the parameter rotation obtained from the frame anonymization parameters comprises the processing unit being operative to determine that the frequency of rotation is less than a predetermined value.

12. The system of claim 8, wherein the processing unit is further operative to provide a reason for rejecting when the first computing device determines to reject the parameter rotation based on the frame anonymization parameters.

13. The system of claim 8, wherein the first computing device comprises an Access Point (AP) and the second computing device comprises a client device.

14. A non-transitory computer-readable medium that stores a set of instructions which when executed perform a method executed by the set of instructions comprising:
accepting, by a first computing device, association with a second computing device;
receiving, by the first computing device, frame anonymization parameters associated with a parameter rotation from the second computing device; and
determining, by the first computing device, to one of accept the parameter rotation based on the frame anonymization parameters and reject the parameter rotation based on the frame anonymization parameters.

15. The non-transitory computer-readable medium of claim 14, wherein determining to one of accept the parameter rotation based on the frame anonymization parameters and reject the parameter rotation based on the frame anonymization parameters comprises determining based on a frequency of rotation for the parameter rotation obtained from the frame anonymization parameters.

16. The non-transitory computer-readable medium of claim 15, wherein determining based on the frequency of rotation for the parameter rotation obtained from the frame anonymization parameters comprises determining that the frequency of rotation is greater than a predetermined value.

17. The non-transitory computer-readable medium of claim 15, wherein determining based on the frequency of rotation for the parameter rotation obtained from the frame anonymization parameters comprises determining that the frequency of rotation is less than a predetermined value.

18. The non-transitory computer-readable medium of claim 14, further comprising providing a reason for rejecting when the first computing device determines to reject the parameter rotation based on the frame anonymization parameters.

19. The non-transitory computer-readable medium of claim 14, wherein the first computing device comprises an Access Point (AP) and the second computing device comprises a client device.

20. The non-transitory computer-readable medium of claim 14, wherein the first computing device comprises a client device and the second computing device comprises an Access Point (AP).
